(19) United States
(12) Patent Application Publication
(10) Pub. No.: US 2020/0123831 A1
(43) Pub. Date: Apr. 23, 2020

(54) FLIP-UP SUPPORT DEVICE AND FURNITURE PIECE WITH THE SAME

(71) Applicant: Dongguan Coomo Furniture Co., Ltd., Dongguan (CN)

(72) Inventor: Guofang XU, Dongguan (CN)

(21) Appl. No.: 16/474,013

(22) PCT Filed: Oct. 26, 2018
(86) PCT No.: PCT/CN2018/112104

§ 371 Date: Jun. 26, 2019

(30) Foreign Application Priority Data
Jan. 16, 2018 (CN) 201820078988.7

(51) Int. Cl. E05F 5/00; E05D 3/16; E05D 13/00; E05F 5/08

(52) U.S. Cl. CPC E05F 5/006; E05D 3/16; E05D 2003/163; E05F 5/08; E05Y 2900/20; E05D 13/12

(57) ABSTRACT

The present invention relates to household articles, in particular to a flip-up support device and a furniture piece with the flip-up support device. The flip-up support device comprises a base (1), an upper connecting assembly and a lower connecting assembly hinged to the base, a flip-up support member hinged to the upper connecting assembly and the lower connecting assembly, a fixing mechanism rotatably connected to the flip-up support member and the upper connecting assembly, a cushion member connected to the lower connecting assembly, and an adjusting assembly for adjusting a cushion force of the cushion member. The cushion force of the cushion member acts on the fixing mechanism via the lower connecting assembly and the flip-up support member. The structure of the flip-up support device is simple and compact, the operation is stable, and the noise is low. The cushion force of the cushion member can be adjusted by the adjusting assembly according to the actual required cushion force, thereby meeting the user's needs and being convenient for the user to use.

### FIELD OF THE INVENTION

The present invention relates to household articles, and more particularly to a flip-up support device and a furniture piece with the flip-up support device.

### BACKGROUND OF THE INVENTION

Household articles, such as cabinets, tables and boxes, are essential for every family. A cabinet and a cabinet door, a table leg and a tabletop, and a box body and a box door are often connected by an opening-closing device. The opening-closing device is convenient for opening and closing the cabinet door, the tabletop and the door. However, the structure of the opening-closing device of the existing cabinets, tables and boxes is complicated and unstable for use, and is opened and closed manually. The cushion force inside the opening-closing device cannot be adjusted. The cushion effect may be affected after long-term use, not meeting the requirements of the daily use.

### SUMMARY OF THE INVENTION

The technical problem to be solved by the present invention is to provide a flip-up support device and a furniture piece with the flip-up support device. The flip-up support device has a simple and compact structure, a stable operation and low noise, and is capable of adjusting a cushion force.

In order to solve the above technical problem, the present invention adopts the following technical solutions:

A flip-up support device comprises a base, an upper connecting assembly and a lower connecting assembly hinged to the base, a flip-up support member hinged to the upper connecting assembly and the lower connecting assembly, a fixing mechanism rotatably connected to the flip-up support member and the upper connecting assembly, a cushion member connected to the lower connecting assembly, and an adjusting assembly for adjusting a cushion force of the cushion member. The cushion force of the cushion member acts on the fixing mechanism via the lower connecting assembly and the flip-up support member.

Preferably, the adjusting assembly includes an adjusting seat mounted to the base, a screw rod rotatably connected to the adjusting seat, and an adjusting member screwedly connected to the screw rod. One end of the cushion member is connected to the adjusting member.

Preferably, the lower connecting assembly includes a first lower connecting member, a second lower connecting member, and a third lower connecting member. One end of the first lower connecting member is hinged to the base, and another end of the first lower connecting member is hinged to one end of the flip-up support member. One end of the second lower connecting member is hinged to a middle portion of the first lower connecting member, and another end of the second lower connecting member is hinged to one end of the third lower connecting member. Another end of the third lower connecting member is hinged to the base. A hinge portion of the second lower connecting member and the third lower connecting member is connected to one end of the cushion member.

Preferably, the upper connecting assembly includes a first upper connecting member and a second upper connecting member. One end of the first upper connecting member is hinged to the base, and another end of the first upper connecting member is hinged to one end of the second upper connecting member. Another end of the second upper connecting member is hinged to the fixing mechanism. A middle portion of the flip-up support member is hinged to a middle portion of the first upper connecting member.

Preferably, the fixing mechanism includes a housing hingedly connected to the flip-up support member and the second upper connecting member, a fixing member connected to the housing, and an opening-closing assembly for limiting the fixing member in the housing. The fixing member is provided with an engaging groove in cooperation with the housing and a buckle groove in cooperation with the opening-closing assembly. The engaging groove and the buckle groove are disposed at two ends of the fixing member, respectively.

Preferably, the opening-closing assembly includes an opening-closing member rotatably connected to the housing and an opening-closing torsion spring disposed between the opening-closing member and the housing. One end of the opening-closing torsion spring leans against the opening-closing member, and another end of the opening-closing torsion spring leans against the housing. The opening-closing member is buckled in the buckle groove.

Preferably, the opening-closing member is provided with a buckle portion for extending into the buckle groove. The housing is provided with an engaging shaft to be received in the engaging groove.

Preferably, the flip-up support device further comprises a damping mechanism mounted on the base. The damping mechanism includes a rotating member and a damper. The rotating member is rotatably connected to the base and configured to get contact with a hinge portion of the first upper connecting member or/and the second upper connecting member. The damper is configured to get contact with the rotating member. The damper is mounted to the base.

Preferably, the rotating member is provided with a first contact surface configured to get contact with the hinge portion of the first upper connecting member and the second upper connecting member, and a second contact surface configured to get contact with an output end of the damper.

The present invention further provides a furniture piece with the above flip-up support device.

The beneficial effects of the present invention are described below. In use, when the fixing mechanism is pulled to move upward, the fixing mechanism drives the flip-up support member and the upper connecting assembly to move upward, the flip-up support member drives the lower connecting assembly to move upward, and the lower connecting assembly compresses the cushion member. In this process, the cushion member cushions the fixing mechanism via the lower connecting assembly, the flip-up support member and the upper connecting assembly. When the fixing mechanism is pushed to move downward, the fixing mechanism drives the flip-up support member and the upper connecting assembly to move downward, the flip-up support member drives the lower connecting assembly to move downward, and the cushion member extends and contacts the lower connecting assembly. The cushion member cushions the upward movement of the fixing mechanism. The adjusting assembly adjusts the displacement of the cushion member, thereby adjusting the cushion force of the cushion member. The structure of the flip-up support device is simple and compact, the operation is stable, and the noise is low. The cushion force of the cushion member can be adjusted by the adjusting assembly according to the actual required cushion force, thereby meeting the user's needs and being convenient for the user to use.

### BRIEF DESCRIPTION OF THE DRAWINGS

FIG. 1 is a perspective view of the furniture piece with the flip-up support device of the present invention;

FIG. 2 is a perspective view of the flip-up support device of the present invention;

FIG. 3 is a perspective view of the flip-up support device of the present invention, without the casing; and

FIG. 4 is an exploded view of the fixing mechanism of the present invention.

### DETAILED DESCRIPTION OF THE PREFERRED EMBODIMENTS

In order to understand the present invention, embodiments of the present invention will now be described, by way of example only, with reference to the accompanying drawings. The following embodiments are intended to illustrate the present invention but are not intended to limit the scope of the present invention.

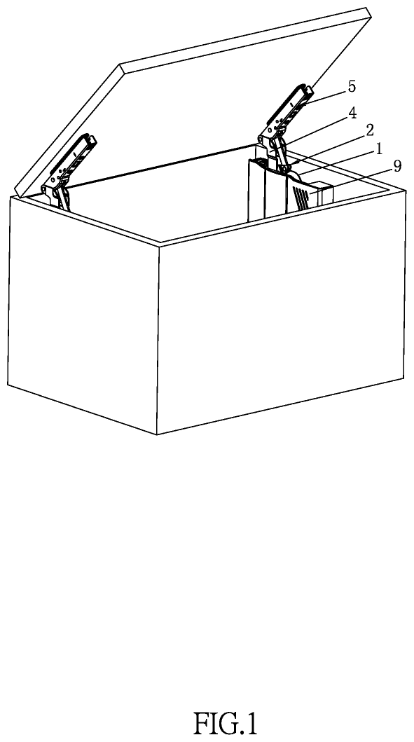

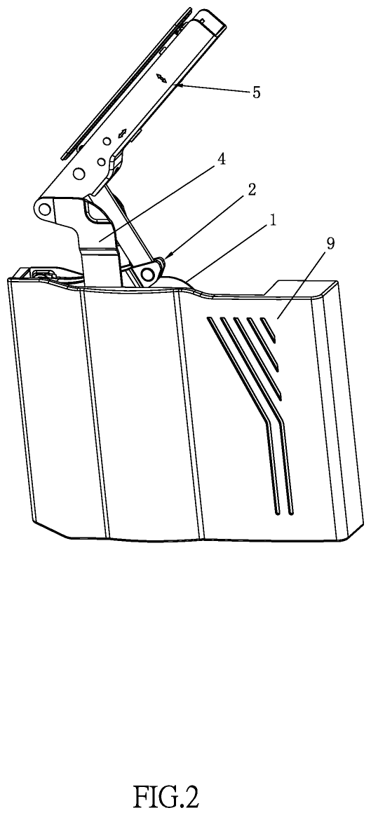

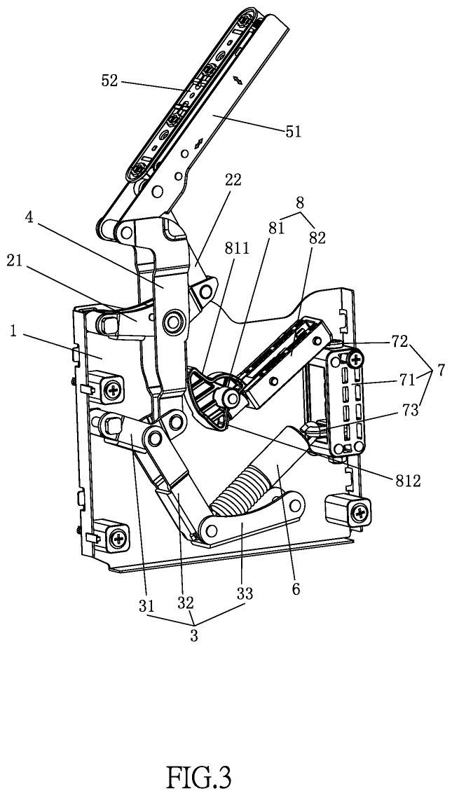

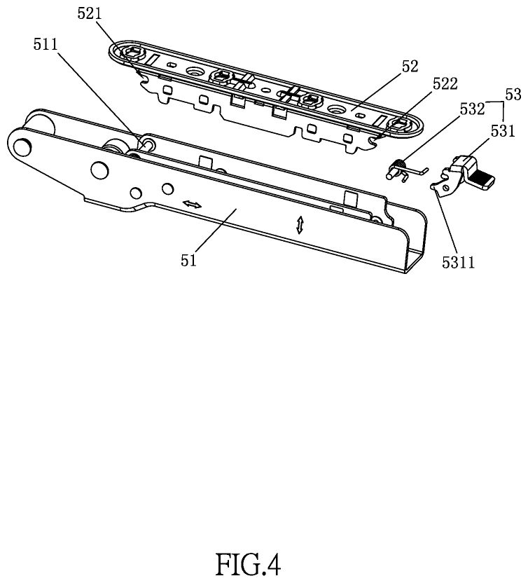

As shown in FIG. 1 to FIG. 4, the present invention provides a flip-up support device, comprising a base 1, an upper connecting assembly 2 and a lower connecting assembly 3 hinged to the base 1, a flip-up support member 4 hinged to the upper connecting assembly 2 and the lower connecting assembly 3, a fixing mechanism 5 rotatably connected to the flip-up support member 4 and the upper connecting assembly 2, a cushion member 6 connected to the lower connecting assembly 3, and an adjusting assembly 7 for adjusting the cushion force of the cushion member 6. The cushion force of the cushion member 6 acts on the fixing mechanism 5 via the lower connecting assembly 3 and the flip-up support member 4. Specifically, the hinge portion of the flip-up support member 4 and the fixing mechanism 5 and the hinge portion of the upper connecting assembly 2 and the fixing mechanism 5 are spaced apart from each other.

When the fixing mechanism 5 is pulled to move upward, the fixing mechanism 5 drives the flip-up support member 4 and the upper connecting assembly 2 to move upward, the flip-up support member 4 drives the lower connecting assembly 3 to move upward, and the lower connecting assembly 3 compresses the cushion member 6. In this process, the cushion member 6 cushions the fixing mechanism 5 via the lower connecting assembly 3, the flip-up support member 4 and the upper connecting assembly 2. When the fixing mechanism 5 is pushed to move downward, the fixing mechanism 5 drives the flip-up support member 4 and the upper connecting assembly 2 to move downward, the flip-up support member 4 drives the lower connecting assembly 3 to move downward, and the cushion member 6 extends and contacts the lower connecting assembly 3. The cushion member 6 cushions the upward movement of the fixing mechanism 5. The adjusting assembly 7 adjusts the displacement of the cushion member 6, thereby adjusting the cushion force of the cushion member 6. The structure of the flip-up support device is simple and compact, the operation is stable, and the noise is low. The cushion force of the cushion member 6 can be adjusted by the adjusting assembly 7 according to the actual required cushion force, thereby meeting the user's needs and being convenient for the user to use.

In this embodiment, the cushion member 6 is a spring. The spring has the advantages of simple structure, low cost, sensitive response, stability, and convenient maintenance.

In this embodiment, the adjusting assembly 7 includes an adjusting seat 71 mounted to the base 1, a screw rod 72 rotatably connected to the adjusting seat 71, and an adjusting member 73 screwedly connected to the screw rod 72. One end of the cushion member 6 is connected to the adjusting member 73. When the cushion member 6 is actually adjusted, the screw rod 72 is rotated, and the screw rod 72 drives the adjusting member 73 to move up and down. The adjusting member 73 drives the cushion member 6 to move and changes the angle of inclination of the cushion member 6, thereby adjusting the cushion force of the cushion member 6.

In this embodiment, the lower connecting assembly 3 includes a first lower connecting member 31, a second lower connecting member 32, and a third lower connecting member 33. One end of the first lower connecting member 31 is hinged to the base 1, and another end of the first lower connecting member 31 is hinged to one end of the flip-up support member 4. One end of the second lower connecting member 32 is hinged to a middle portion of the first lower connecting member 31, and another end of the second lower connecting member 32 is hinged to one end of the third lower connecting member 33. Another end of the third lower connecting member 33 is hinged to the base 1. The hinge portion of the second lower connecting member 32 and the third lower connecting member 33 is connected to one end of the cushion member 6. In the actual operation, the flip-up support member 4 drives the first lower connecting member 31 to turn, the first lower connecting member 31 drives the second lower connecting member 32 to move, the second lower connecting member 32 drives the third lower connecting member 33 to turn, the hinge portion of the second lower connecting member 32 and the third lower connecting member 33 is in contact with the cushion member 6, and the cushion member 6 cushions the flip-up support member 4 via the lower connecting assembly 3.

In this embodiment, the upper connecting assembly 2 includes a first upper connecting member 21 and a second upper connecting member 22. One end of the first upper connecting member 21 is hinged to the base 1, and another end of the first upper connecting member 21 is hinged to one end of the second upper connecting member 22. Another end of the second upper connecting member 22 is hinged to the fixing mechanism 5. A middle portion of the flip-up support member 4 is hinged to a middle portion of the first upper connecting member 21. In the actual operation, the fixing mechanism 5 drives the second upper connecting member 22 and the flip-up support member 4 to move, and the second upper connecting member 22 drives the first upper connecting member 21 to rotate. Wherein, the first upper connecting member 21 acts as a limit on the movement of the flip-up support member 4 to prevent the flip-up support member 4 from swinging arbitrarily and improve the stability of the movement of the flip-up support member 4.

In this embodiment, the fixing mechanism 5 includes a housing 51 hingedly connected to the flip-up support member 4 and the second upper connecting member 22, a fixing member 52 connected to the housing 51, and an opening-closing assembly 53 for limiting the fixing member 52 in the housing 51. The fixing member 52 is provided with an engaging groove 521 in cooperation with the housing 51 and a buckle groove 522 in cooperation with the opening-closing assembly 53. The engaging groove 521 and the buckle groove 522 are disposed at two ends of the fixing member 52, respectively. The fixing member 52 is configured to connect an external panel.

The housing 51 is detachably connected to the fixing member 52 to facilitate the disassembly and assembly of the housing 51 and the fixing member 52. When the housing 51 and the fixing member 52 are assembled, the fixing member 52 is mounted to the housing 51, the fixing member 52 is closed with the housing 51, and the opening-closing assembly 53 limits the fixing member 52 to be in the housing 51. The engaging groove 521 of the fixing member 52 is engaged with the housing 51, and the buckle groove 522 of the fixing member 52 is buckled to the opening-closing assembly 53. When disassembled, the opening-closing assembly 53 is pressed to turn the opening-closing assembly 53. The opening-closing assembly 53 is disengaged from the buckle groove 522 of the fixing member 52, so that the fixing member 52 and the housing 51 are opened. The fixing member 52 and the housing 51 can be disassembled by simply displacing the fixing member 52 to disengage the engaging groove 521 of the fixing member 52 from the housing 51. The fixing mechanism 5 has a simple and compact structure. The engaging groove 521 and the buckle groove 522 of the fixing member 52 are connected to the housing 51 and the opening-closing assembly 53, respectively. The opening-closing assembly 53 controls the opening and closing of the fixing member 52 and the housing 51, and the operation is simple and stable. It is convenient to disassemble and assemble the fixing member 52 and the housing 51, thereby improving the disassembly and assembly efficiency and facilitating the use.

In this embodiment, the opening-closing assembly 53 includes an opening-closing member 531 rotatably connected to the housing 51 and an opening-closing torsion spring 532 disposed between the opening-closing member 531 and the housing 51. One end of the opening-closing torsion spring 532 leans against with the opening-closing member 531, and another end of the opening-closing torsion spring 532 leans against the housing 51. The opening-closing member 531 is buckled in the buckle groove 522. Specifically, the opening-closing member 531 is provided with a buckle portion 5311 for extending into the buckle groove 522. The housing 51 is provided with an engaging shaft 511 to be received in the engaging groove 521.

The engaging shaft 511 of the housing 51 is engaged in the engaging groove 521 of the fixing member 52. The engagement between the engaging groove 521 and the engaging shaft 511 improves the positional accuracy and efficiency of assembling the housing 51 and the fixing member 52 and facilitates the disassembly and assembly of the housing 51 and the fixing member 52. When the fixing member 52 is disassembled and assembled, the opening-closing member 531 is pressed to turn the opening-closing member 531 relative to the housing 51. The opening-closing member 531 compresses the opening-closing torsion spring 532, so that the buckle portion 5311 is disengaged from the buckle groove 522 of the fixing member 52 to release the pressing force acting on the opening-closing member 531. The opening-closing torsion spring 532 drives the opening-closing member 531 to be returned, so that the buckle portion 5311 is buckled to the buckle groove 522 of the fixing member 52, thereby realizing the opening and closing of the fixing member 52 and the housing 51. The opening-closing assembly 53 has a simple structure, a sensitive reaction, a stable opening and closing, and a quick operation, which facilitates the disassembly and assembly of the fixing member 52 and the housing 51.

In this embodiment, the flip-up support device further comprises a damping mechanism 8 mounted on the base 1. The damping mechanism 8 includes a rotating member 81 and a damper 82. The rotating member 81 is rotatably connected to the base 1 and configured to get contact with the hinge portion of the first upper connecting member 21 or/and the second upper connecting member 22. The damper 82 is configured to get contact with the rotating member 81. The damper 82 is mounted to the base 1. The damper 82 enables the rotating member 81 to get contact with the first upper connecting member 21 or/and the second upper connecting member 22. Specifically, the rotating member 81 is provided with a first contact surface 811 configured to get contact with the hinge portion of the first upper connecting member 21 and the second upper connecting member 22 and a second contact surface 812 configured to get contact with an output end of the damper 82.

When the fixing mechanism 5 drives the upper connecting assembly 2 to move downward, the hinge portion of the first upper connecting member 21 and the second upper connecting member 22 is in contact with the first contact surface 811 of the rotating member 81, so that the rotating member 81 rotates, and the second contact surface 812 of the rotating member 81 is in contact with the damper 82. The damping force of the damper 82 acts on the fixing mechanism 5 via the upper connecting assembly 2. The damper 82 enables the fixing mechanism 5 to move downward slowly, thereby reducing noise. When the fixing mechanism 5 drives the upper connecting assembly 2 to move upward, the damper 82 is in contact with the second contact surface 812 of the rotating member 81, so that the rotating member 81 rotates, and the first contact surface 811 of the rotating member 81 is in contact with the hinge portion of the first upper connecting member 21 and the second upper connecting member 22 to facilitate upward movement of the upper connecting assembly 2, improving the efficiency of the upward movement of the upper connecting assembly 2 and the fixing mechanism 5.

In this embodiment, the base 1 is provided with a casing 9 for protecting the lower connecting assembly 3, the damping mechanism 8, the cushion member 6, the adjusting assembly 7, the upper connecting assembly 2 and the flip-up support member 4 so as to prolong the service life of the flip-up support device.

The present invention also provides a furniture piece with the flip-up support device. The furniture piece with the flip-up support device has the technical effect of the above flip-up support device, and will not be further described hereinafter.

All the technical features in this embodiment can be freely combined according to actual needs.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A flip-up support device, comprising a base (1), an upper connecting assembly (2) and a lower connecting assembly (3) hinged to the base (1), a flip-up support member (4) hinged to the upper connecting assembly (2) and the lower connecting assembly (3), a fixing mechanism (5) rotatably connected to the flip-up support member (4) and the upper connecting assembly (2), a cushion member (6) connected to the lower connecting assembly (3), and an adjusting assembly (7) for adjusting a cushion force of the cushion member (6), wherein the cushion force of the cushion member (6) acts on the fixing mechanism (5) via the lower connecting assembly (3) and the flip-up support member (4).

2. The flip-up support device as claimed in claim 1, wherein the adjusting assembly (7) includes an adjusting seat (71) mounted to the base (1), a screw rod (72) rotatably connected to the adjusting seat (71) and an adjusting member (73) screwedly connected to the screw rod (72), wherein one end of the cushion member (6) is connected to the adjusting member (73).

3. The flip-up support device as claimed in claim 1, wherein the lower connecting assembly (3) includes a first lower connecting member (31), a second lower connecting member (32), and a third lower connecting member (33); one end of the first lower connecting member (31) is hinged to the base (1), another end of the first lower connecting member (31) is hinged to one end of the flip-up support member (4); one end of the second lower connecting member (32) is hinged to a middle portion of the first lower connecting member (31), another end of the second lower connecting member (32) is hinged to one end of the third lower connecting member (33), another end of the third lower connecting member (33) is hinged to the base (1); a hinge portion of the second lower connecting member (32) and the third lower connecting member (33) is connected to one end of the cushion member (6).

4. The flip-up support device as claimed in claim 1, wherein the upper connecting assembly (2) includes a first upper connecting member (21) and a second upper connecting member (22); one end of the first upper connecting member (21) is hinged to the base (1), another end of the first upper connecting member (21) is hinged to one end of the second upper connecting member (22), another end of the second upper connecting member (22) is hinged to the fixing mechanism (5); a middle portion of the flip-up support member (4) is hinged to a middle portion of the first upper connecting member (21).

5. The flip-up support device as claimed in claim 4, wherein the fixing mechanism (5) includes a housing (51) hingedly connected to the flip-up support member (4) and the second upper connecting member (22), a fixing member (52) connected to the housing (51), and an opening-closing assembly (53) for limiting the fixing member (52) in the housing (51); the fixing member (52) is provided with an engaging groove (521) in cooperation with the housing (51) and a buckle groove (522) in cooperation with the opening-closing assembly (53); the engaging groove (521) and the buckle groove (522) are disposed at two ends of the fixing member (52), respectively.

6. The flip-up support device as claimed in claim 5, wherein the opening-closing assembly (53) includes an opening-closing member (531) rotatably connected to the housing (51) and an opening-closing torsion spring (532) disposed between the opening-closing member (531) and the housing (51); one end of the opening-closing torsion spring (532) leans against the opening-closing member (531), another end of the opening-closing torsion spring (532) leans against the housing (51), and the opening-closing member (531) is buckled in the buckle groove (522).

7. The flip-up support device as claimed in claim 6, wherein the opening-closing member (531) is provided with a buckle portion (5311) for extending into the buckle groove (522), and the housing (51) is provided with an engaging shaft (511) to be received in the engaging groove (521).

8. The flip-up support device as claimed in claim 4, further comprising a damping mechanism (8) mounted on the base (1), the damping mechanism (8) including a rotating member (81) and a damper (82), the rotating member (81) being rotatably connected to the base (1) and configured to get contact with a hinge portion of the first upper connecting member (21) or/and the second upper connecting member (22), the damper (82) being configured to get contact with the rotating member (81), the damper (82) being mounted to the base (1).

9. The flip-up support device as claimed in claim 8, wherein the rotating member (81) is provided with a first contact surface (811) configured to get contact with the hinge portion of the first upper connecting member (21) and the second upper connecting member (22), and a second contact surface (812) configured to get contact with an output end of the damper (82).

10. A furniture piece with the flip-up support device as claimed in claim 1.
